(19) United States
(12) Patent Application Publication
(10) Pub. No.: US 2002/0087695 A1
(43) Pub. Date: Jul. 4, 2002

(54) Method and system for network management

(76) Inventors: Satoko Araki, Yokohama (JP); Yoshimi Nakagawa, Yokohama (JP); Takeshi Sato, Yokohama (JP); Takao Iwata, Yokohama (JP); Masafumi Hikari, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/920,887

(22) Filed: Aug. 3, 2001

(30) Foreign Application Priority Data
Nov. 14, 2000 (JP) 2000-346477

(51) Int. Cl. G06F 15/173

(52) U.S. Cl. 709/226

(57) ABSTRACT

A method for managing a network system via a managed object (MO), wherein a system administrator inputs to a network element connected to a maintenance terminal, a system ID for a network element under network management. The network element to be managed receives the system ID and sends back its own address to the network element connected to the maintenance terminal. The network element connected to the maintenance terminal, when receiving the address, sends a MO generator Protocol Data Unit (PDU) to the network element to be managed, and then allows the network element to be managed to generate a MO therein. The network element connected to the maintenance terminal also receives the MO generator PDU from the network element to be managed, and generates the MO for the network element to be managed on its own network element.

### BACKGROUND OF THE INVENTION

The continuing spread of the information society, as well as the colossal size and complexity of network systems have made network management increasingly indispensable. In the international standard for networks called Open Systems Interconnection (OSI), a method has been proposed for carrying out network management by using a model called “Managed Object” (hereafter abbreviated to MO) modeled on an actual system. The OSI managed object can define by all objects managed on a network. The attributes and action can be described by an “object oriented” concept.

This invention is described presuming the use of OSI managed objects. The OSI managed objects and overall principle relating to OSI managed objects are described here.

The principle of OSI managed objects is first explained using FIG. 7. The structure of the SAP address for OSI and the AP-Title and AE-Title are described in FIG. 7.

The architecture and the protocol in OSI are defined utilizing a layer model.

The SAP (Service Access Point) is defined as the access point for each OSI layer. The SAP for the network layer for example, is the NSAP (Network Service Access Point) and the SAP for the presentation layer is the PSAP (Presentation Service Access Point). Addresses for their access points are respectively called the NSAP address and the PSAP address with the relation shown in FIG. 7A. In other words, the PSAP address is made by adding to the header, a selector consisting of supplemental information for the transport layer, session layer and presentation layer constituting the upper network layers. The selector consisting of supplemental information for each layer is called the OSI selector.

The OSI, on the other hand, uses a principle called the AE-Title to access the network system as seen from the application layer. As shown in FIG. 7B, the AE-Title is comprised of an AE qualifier and an AP-Title. The AE qualifier describes attributes of the application. The AP-title is expressed in layers for univocally identifying each network operating point and the tail of the AP-Title contains a system number. The previously described SAP address is a physical address, and the AP-Title is a system logic address.

The OSI managed object can be defined according to user's needs. The OSI provides a standard address management MO for address management. Typical MO is listed in Table 1. An instance for each class is generated for performing network management, and attributes are recorded in that instance.

TABLE 1

| | ADDRESS | |
|---|---|---|
| ITEM | MANAGEMENT | |
| NO. | MO CLASS | DESCRIPTION |
| 1 | sap2 | Holds attributes presentation layer |
| | | service access point (PSAP) |
| 2 | communicationsEntity | Holds distinguishing name (DN) of |
| | | corresponding sap2 as the attribute. |
| | ApplicationProcess | Holds the attributes of the AP-Title. |
| 3 | | Each instance has an AE qualifier added |
| | | to the instance ID, and manages the AE- |
| | | Title required for establishing an |
| | | association. |

The Sap2 class as described in Table 1 is address information relating to PSAP. The application process class is information relating to the AE-Title and the AP-Title. The DN of the communication entity class is an index for identifying the instance of the Sap2 class.

The core of each network system defined in the above mentioned OSI possesses an NSAP address and a PSAP address. An address independent of these NSAP and PSAP addresses, and available for defining a system ID to allow recognizing a system, would prove convenient.

The TARP (Target ID Address Resolution Protocol) function defined in GR-253-CORE of Bellcore, changes the system nickname consisting of the TID (Target Identifier), to the system NSAP address, and conversely changes the NSAP address to the TID. A function is also possessed for notifying other systems that the TID and NSAP addresses have been changed.

In a system comprised of mutually linked network elements, MO listed on the other party's network element are needed on the network element connected to the graphical local craft terminal in order to maintain network systems in remote locations. Therefore, when making new additions to the network elements such as when expanding the network elements or when changing the addresses of those network elements, the MOs listed in the network element that was changed, must be made and distributed to all network elements that attempt to access the network element that underwent the changes, creating the problem of an increasingly large maintenance or servicing work load.

### SUMMARY OF THE INVENTION

The present invention aims to reduce the servicing workload on a system administrator, by automatically generating a MO and allowing access, even in a case without the MO for the changed network element, just by entering to the network element directly connected to a graphical local craft terminal, the system ID and address of a network element that underwent the changes or expansion.

In order to achieve the object, the present invention is provided to perform the following processing in a network system. When system expansion or its address change occurs in a network element, a system administrator enters the system ID or the network address of the network element that underwent the changes or expansion. The network element directly connected to the graphical local craft terminal, with use of its function to change the system ID-address that changes the system ID to an NSAP address and vice versa, sends the data entered by the system administrator, to the other party's network element. The other party's network element sends back corresponding data based on the function.

The network element directly connected to the graphical local craft terminal, afterwards sends its own system No., PSAP address and system ID to the other party's network element. The other party's network element then generates an MO based on these data, and in the same way sends back its own system No., PSAP address and system ID. Based on the data returned from the other party's network element, the network element directly connected to the graphical local craft terminal, generates the MO of the other party's network element. Thus, through the Mo generated on both network elements, the system administrator can access the other party Is network element via the graphical local craft terminal so as to perform maintenance work.

In short, the MO is automatically generated and sent so that the system administrator is relieved of the task of making and sending an MO to thereby alleviate the workload on the system administrator.

### BRIEF DESCRIPTION OF THE DRAWINGS

FIG. 1 is a system block diagram showing the network system of the present invention;

FIG. 2 is a system block diagram showing the network system of the present invention when a new network element D has been added;

FIG. 3 is a communications sequence chart for the network management method of the first embodiment of the present invention;

FIG. 4 is a communications sequence chart for the network management method of the first embodiment of the present invention;

FIG. 5 is a communications sequence chart for the network management method of the second embodiment of the present invention;

FIG. 6 is a communications sequence chart for the network management method of the second embodiment of the present invention; and

FIG. 7 illustrates the structure of the SAP address of the OSI, the AP-Title, and AE-Title.

### DESCRIPTION OF THE PREFERRED EMBODIMENTS

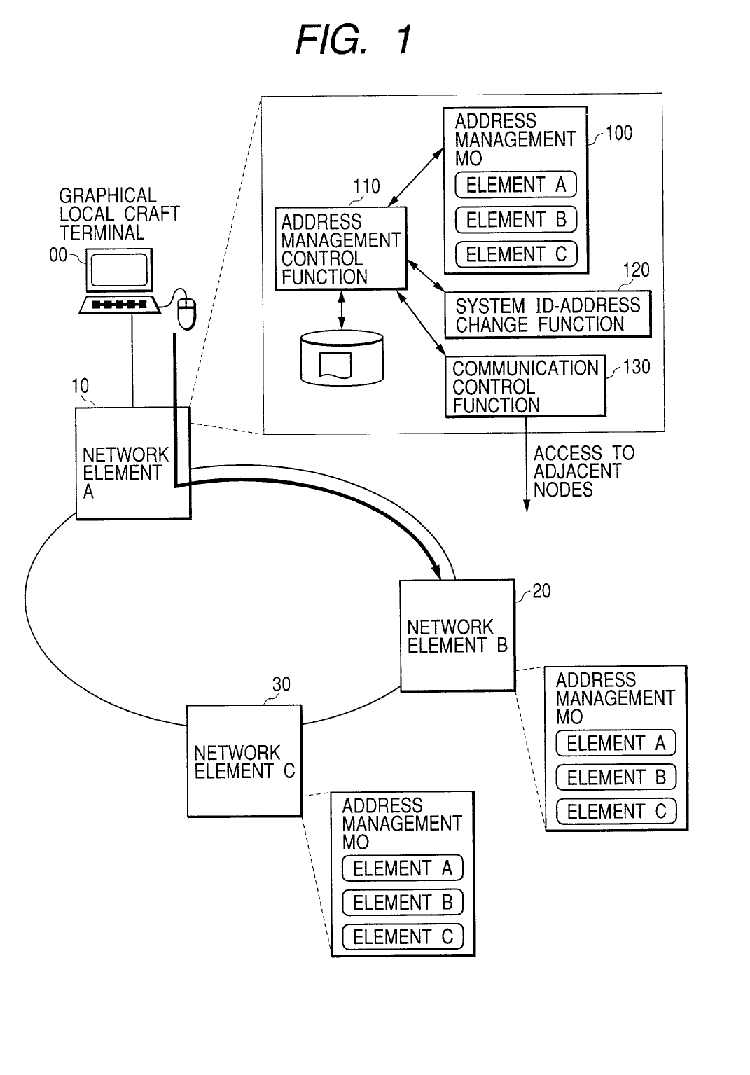

The system structure of the network system of the present invention is first described while referring to the FIG. 1.

FIG. 1 is a system block diagram of the network system of the present invention.

In this network system, the network element A10, the network element B20, and the network element C30 are connected in link topology allowing mutual communication.

Each network element possesses an address management MO100 which consists of a MO of an OSI as explained previously, and network management is performed by means of this MO. An address management control function 110 in each network element constitutes the means for accessing this MO. A system ID-address change function 120 is a function to alternately change the system ID assigned to this system and the NSAP address of the OSI. A communication control function 130 is a function for communication of that network element with other network elements. The network element A10 connected to a graphical local craft terminal 00 is configured to allow servicing all these network elements.

MOs for the system A, system B, and system C are generated as the address management MO100 of the network element A10. The network element A10, the network element B20, and the network element C30 are in this way also capable of being maintained from the network element A10.

Address management MO for other network elements are in the same way generated in the network element B20 and the network element C30 so that other systems are interactively recognized and network management performed.

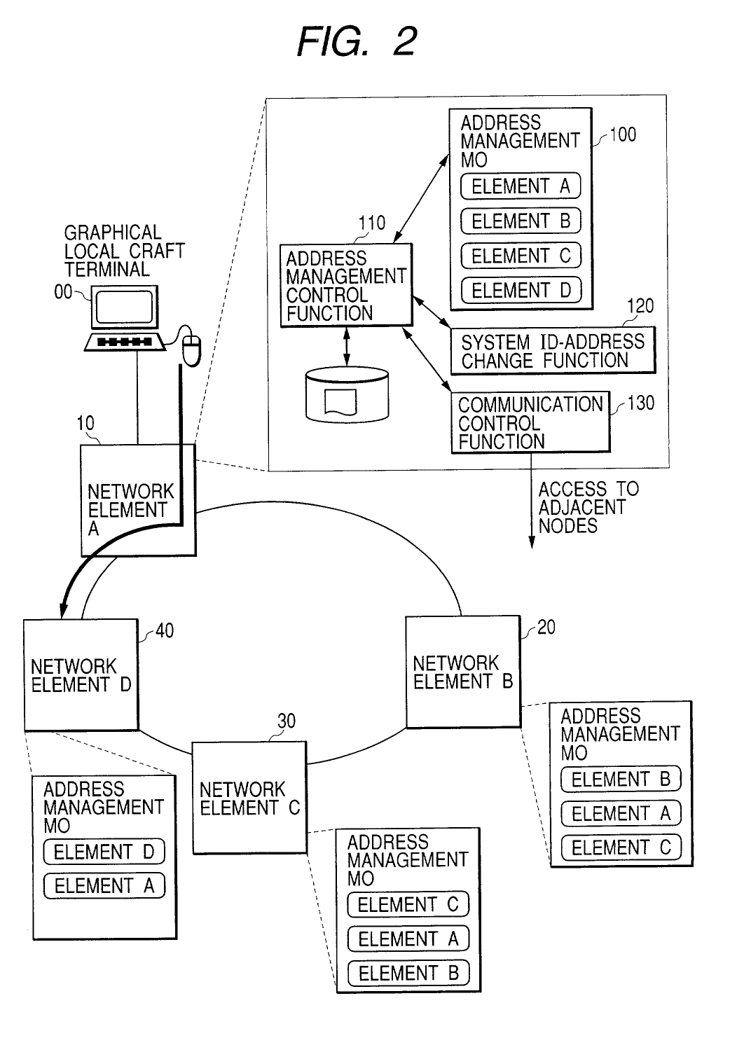

The first embodiment of the present invention is next described assuming the use of the above-mentioned network system structures, while referring to FIG. 2 through FIG. 4.

FIG. 2 is a system block diagram showing the network system of the present invention when a new network element D40 has been added. In this configuration, a new network element D40 has been added between the network element A10 and the network element C30.

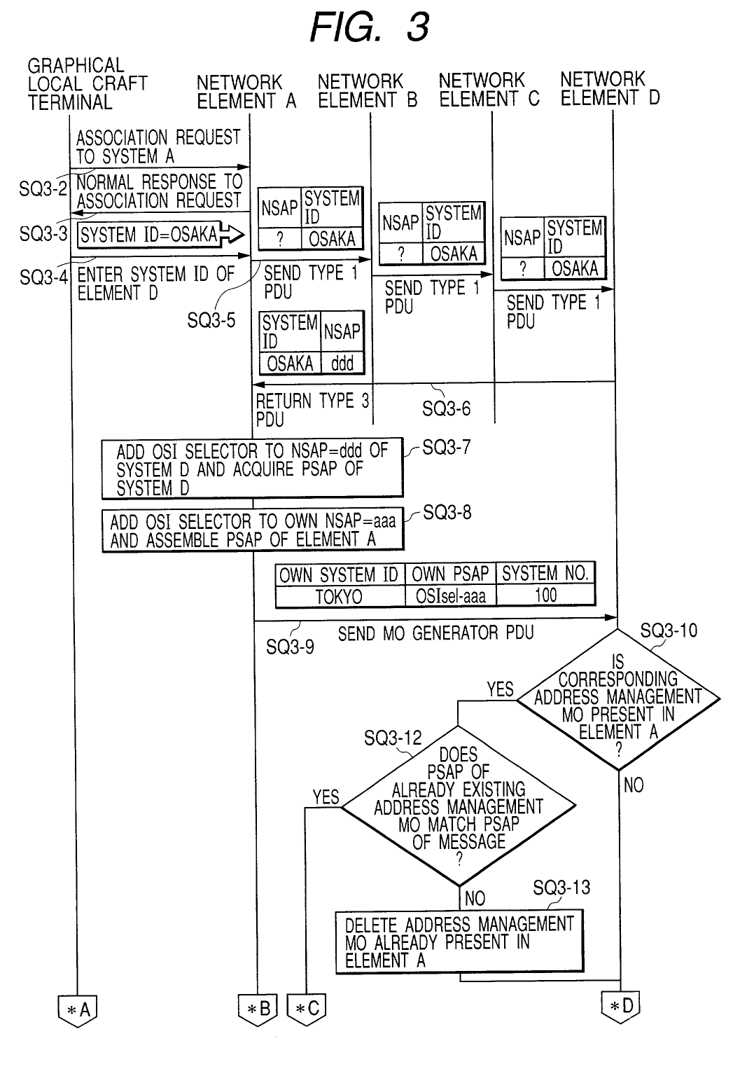

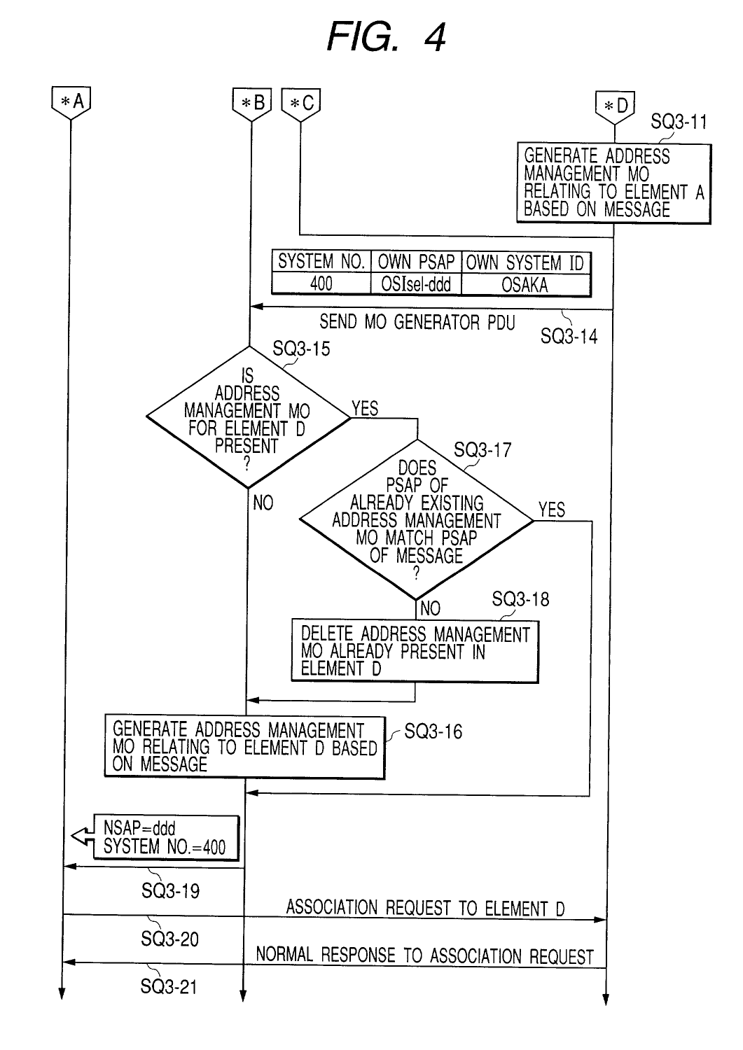

FIG. 3 and FIG. 4 are communications sequence charts for the network management method of the first embodiment of the present invention.

The network management method of the present invention in this case, automatically generates an MO in each network element, with the object of alleviating the network management workload.

The following description, of the network element A10, assumes the system ID is TOKYO, the NSAP address is aaa, and the system No. is 100. The description of the added network element D, on the other hand, assumes the system ID is OSAKA, the NSAP address is ddd, and the system No. is 400.

The system ID is added to each network element and is a kind of nickname.

In the network management method of the present embodiment, the system ID “OSAKA” of the added network element D40 is input to the network element A10 via the graphical local craft terminal 00. The address management MO 100 for the network element D can in this way be generated in the network element A10 having graphical local craft terminal 00 as shown in FIG. 2, while the address management MO 100 for network element A can be generated in the newly added network element D40. The method for generating the MO is described next.

First of all, when attempting to connect to the network element A10, an association request is issued from the graphical local craft terminal 00 (SQ3-2), and a response is normally received from the network element A10 (SQ3-3). A connection is in this way established, and communication is afterwards possible to the network element A10 from the graphical local craft terminal 00. After the network element A10 becomes accessible, the system ID OSAKA of the network element D, is input from the graphical local craft terminal 00 (SQ3-4).

The network element A10 assembles a PDU (Protocol Data Unit) from the system ID input through the system ID-address change function 120, to inquire about the NSAP address in each network element, and sends the PDU along the network (SQ3-5). Note that this PDU for asking the NSAP address from the system ID is called a Type 1 PDU.

If the item in the PDU request does not match the system IDs of the network element B20 and the network element C30, the PDU is sent to the next connected network element D40. If the network element D40, after comparing the Type 1 PDU data with its own system ID, finds that the Type 1 PDU data matches its own system ID, it sends back a PDU set with network element 40's own NSAP address of ddd to the network element A10 (SQ3-6). Note that the PDU set with the system ID and the NSAP address of ddd is called a Type 3 PDU.

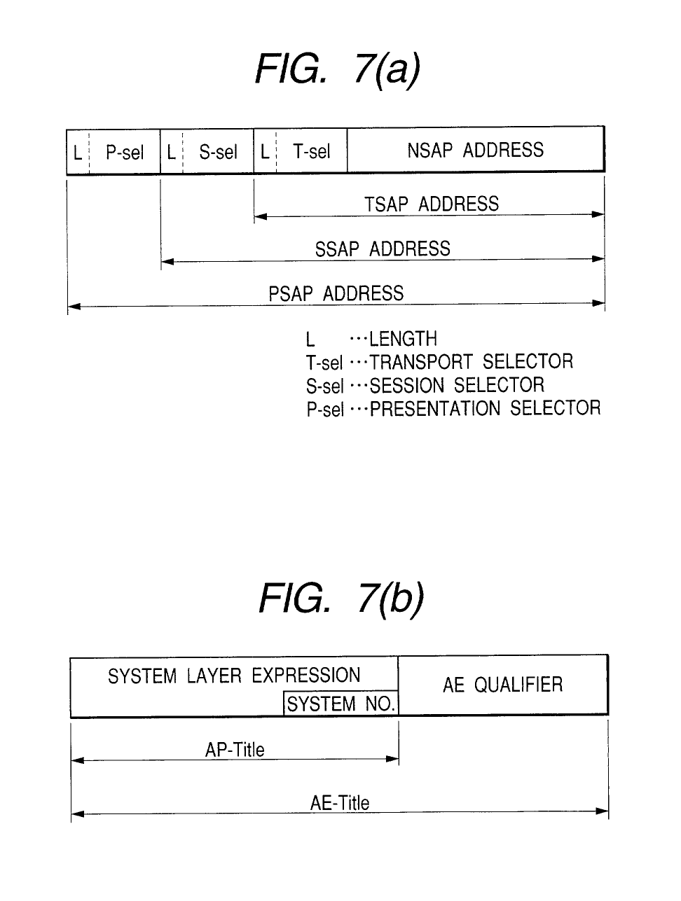

The network element A10, when receiving this Type 3 PDU, extracts the NSAP address of ddd from the PDU, adds OSI selectors to, and makes a PSAP address (SQ3-7). Note that a PSAP address is made by adding to the NSAP address, a transport layer, session layer and presentation layer as shown in FIG. 7A.

The network element A10 next extracts the PSAP address from the Sap2 class instance attribute of its own address management MO 100 (SQ3-8).

The network element A10, using its own system ID of TOKYO, its own PSAP address and its own system number of 100, generates one PDU, and directly sends the PDU to the network element D40 (SQ3-9). Note that this PDU is called an MO generator PDU. The PSAP address of the network element D40 is known at this stage so the PDU can be sent directly to the network element D40 without being sent by way of other network elements.

The network element D40 receives this MO generator PDU, and generates an address management MO 100 for the network element A10 by utilizing the PSAP address and system number of this received PDU.

The network element D40 checks to determine whether or not an address management MO 100 corresponding to the network element A10 is already present (SQ3-10). The network element D40, if not present, generates an address management MO 100 corresponding to the network element A10, based on the MO generator PDU (SQ3-11), while, if already present, it checks to determine whether the PSAP address within the message matches the managed PSAP address (SQ3-12). If the two addresses are matched, then no processing is implemented. However if not found to be a match, then the address is determined to have been changed, and the previously existing address management MO 100 corresponding to the network element A10 is deleted. An address management MO 100 is then again generated corresponding to the network element A10, utilizing the MO generator PDU (SQ3-13).

Next, the network element D40 receives the MO generator PDU from the network element A10, and when the processing is finished, generates an MO generator PDU per its own system ID of OSAKA, own NSAP address of ddd, and own system number of 400, and sends this PDU to the network element A10 (SQ3-14). Here also, the network element D40 already knows the PSAP address for the network element A10, so the MO generator PDU can be sent directly to the network element A10.

Hereafter, in the same way, the network element A10 receives the MO generator PDU from the network element D40, and the procedure for generating an address management MO 100 corresponding to the network element D40 using the system number and the PSAP address of the received PDU is explained.

First of all a check is made to find if an address management MO 100 corresponding to the network element D40 is already present (SQ3-15). If not present, then an address management MO 100 relating to the network element D40 is made based on the MO generator PDU (SQ3-16). If already present, then a comparison is made to find if the PSAP address within the message matches the managed PSAP address (SQ3-17) and if the two addresses are matched, no processing is implemented. However if not found to be matched, the address is determined to have been changed, and the previously existing address management MO 100 corresponding to the network element D40 is deleted. An address management MO 100 is then again generated corresponding to the network element D40, utilizing the MO generator PDU (SQ3-18).

An address management MO 100 is in this way mutually generated in both the network element A10 and the network element D40 as shown in FIG. 2. The network element A10 then, sends back the NSAP address ddd, and the system number 400 of network element D40 to the graphical local craft terminal 00 as a message that the processing is complete.

When the above processing is complete, a system administrator makes an association request to the network element D40 using the graphical local craft terminal 00 (SQ3-20) and a normal reply is received (SQ3-21). A connection with the network element D40 is established in this way and various operations relating to network management on the network element D40 are now possible, from the local graphical terminal connected to the network element A10.

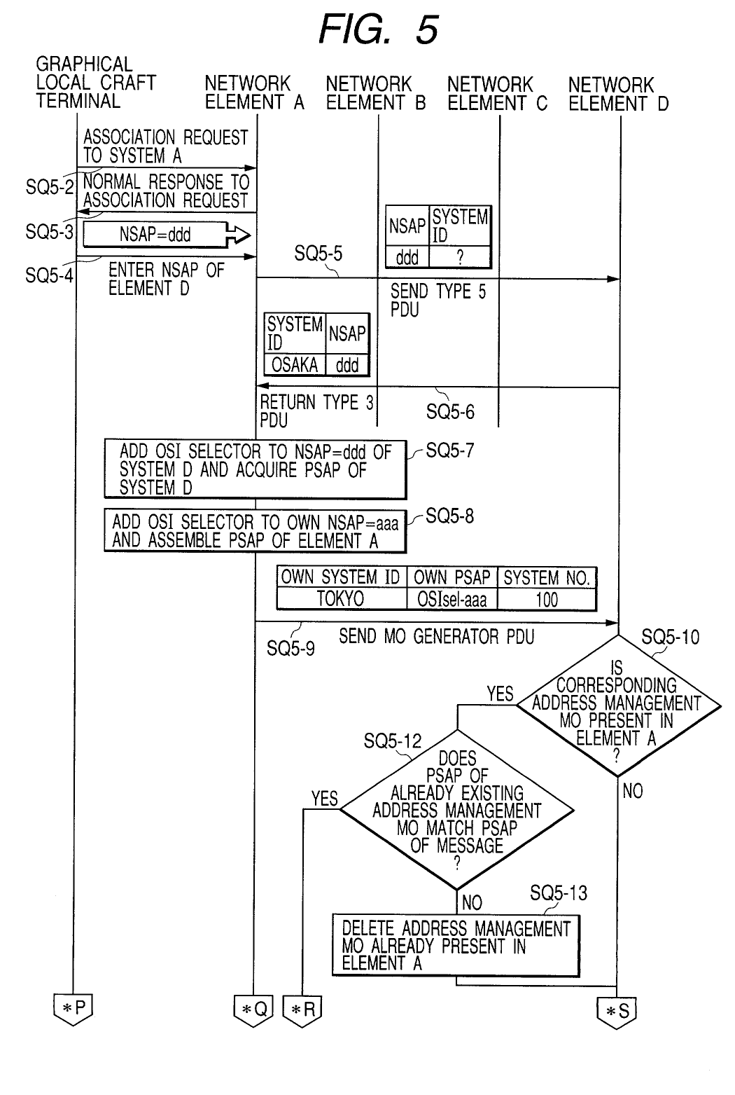

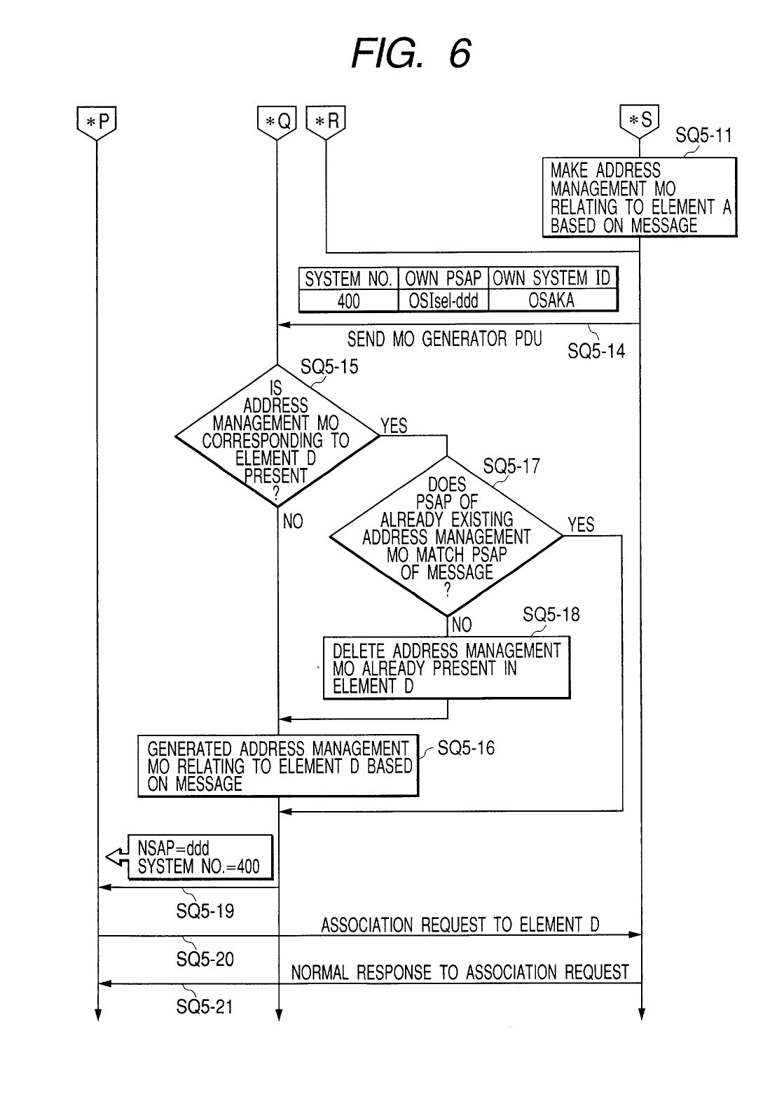

The second embodiment of the present invention is next explained while referring to FIG. 5 and FIG. 6 assuming the above network element structure as a prerequisite. FIG. 5 and FIG. 6 are communications sequence charts for the network management method of the second embodiment of the present invention.

As explained in the first embodiment, when the network structure of FIG. 1 is changed to the structure of FIG. 2, the system ID of the network element D40 is input from the graphical local craft terminal 00, and by changing the system ID to an NSAP address, generates the address management MO 100.

In the present embodiment, the network structure is the same, however contrary to the first embodiment, the NSAP address is input from the graphical local craft terminal 00, the NSAP address changed to a system ID, and the address management MO 100 generated.

During servicing of the network element, sometimes the address of the network element is known but the system ID constituting the nickname is not known. Or even if the system ID is known, it may have been changed, doubts exist and a check must sometimes be made. At such times, the functions explained for this embodiment are useful.

In the case of this embodiment, a new network element D has been added between the network element A10 and the network element C30, in the network element structure of FIG. 1.

In the network management method of this embodiment also, the same as in the first embodiment, an MO is automatically generated in each network element with the aim of alleviating the network management workload. Contrary to the network management method of the first embodiment however, an NSAP address of ddd of the added network element D is input from the graphical local craft terminal 00. As shown in FIG. 2, the generating of an address management MO 100 of network element D in the network element A10 having the graphical local craft terminal 00, and also the generating of an address management MO 100 of the network element A in the newly added network element D40, is the same as the first embodiment.

First of all, an association request is issued from the graphical local craft terminal 00 connected to the network element A10 (SQ5-2), and a normal reply received from the network element A10 (SQ5-3). A connection is in this way established, and communication is afterwards possible to the network element A10 from the graphical local craft terminal 00. After the network element A10 becomes accessible, the NSAP address of ddd of network element D, is input from the graphical local craft terminal 00 (SQ5-4).

The network element A10 assembles a PDU (Protocol Data Unit) from the system ID input from the graphical local craft terminal 00 by the system ID-address change function 120, to inquire about the system ID to each system element that was input, and sends the PDU over the network (SQ5-5). This PDU for asking the system ID from the NSAP address is called a Type 5 PDU.

Here, unlike the first embodiment, the NSAP address of the network element D40 is known so the PDU can be sent directly to the network element D40.

When the Type 5 PDU arrives at the network element D40, a Type 3 PDU set with the network element D40's own system ID of OSAKA is sent back to the network element A10 (SQ5-6).

When the network element A10 receives the Type 3 PDU, it extracts the NSAP address from that PDU, adds the OSI selectors, and thereby makes a PSAP address made (SQ5-7).

The network element A10 next extracts the PSAP address from the sap2 class instance attribute of its own address management MO 100 (SQ5-8). The network element A10 then generates MO generator PDU using its own system ID of TOKYO, its own PSAP address and its own system number of 100, and directly sends the PDU to the network element D40 (SQ5-9).

These procedures are the same as for the first embodiment. The procedures from here onwards are also completely identical to the first embodiment. This MO generator PDU is received in the network element D40, and an address management MO 100 for the network element A10 is generated from the PSAP address and system number of this received PDU.

First, a check is made to determine whether or not an address management MO 100 corresponding to the network element A10 is already present (SQ5-10). If not present, an address management MO 100 for the network element A10 is then generated, based on the MO generator PDU (SQ5-11). However, if already present, a comparison is made to find if the PSAP address within the message matches the managed PSAP address (SQ5-12) and if the two addresses are matched, then no processing is implemented. However if not found to be matched, then the address is determined to have been changed, and the previously existing address management MO 100 corresponding to the network element A10 is deleted. An address management MO 100 is then again generated corresponding to the network element A10, based on the MO generator PDU (SQ5-13).

Next, the network element D40 receives the MO generator PDU from the network element A10, and when the processing is finished, generates an MO generator PDU using its own system ID of OSAKA, own PSAP address, and its own system number of 400, and sends this PDU to the network element A10 (SQ5-14).

The network element A checks to find if an address management MO 100 corresponding to the network element D40 is already present (SQ5-15). If not present, then an address management MO 100 relating to the network element D40 is made based on the MO generator PDU (SQ5-16). If already present, the network element A10 compares to find if the PSAP address within the message matches the managed PSAP address (SQ5-17) and if the two addresses are matched, then no processing is implemented. However if not found to be matched, then the address is determined to have been changed, and the previously existing address management MO 100 corresponding to the network element D40 is deleted. An address management MO 100 is then again generated corresponding to the network element D40, based on the MO generator PDU (SQ5-18).

An address management MO 100 is in this way mutually generated in both the network element A10 and the network element D40 as shown in FIG. 2. The network element A10 then, the same as in the first embodiment, sends back an NSAP address of ddd and system number 400 of network element D40 to the graphical local craft terminal 00 as a message that the processing is complete.

When the above processing is complete, a system administrator makes an association request to the network element D40 using the graphical local craft terminal 00 (SQ5-20) and a normal reply is received (SQ5-21). A connection with the network element D40 is established in this way and various operations relating to network management on the network element D40 are now possible, from the local graphical terminal connected to the network element A10.

In the present invention, when a change in the system has occurred such as the adding of a network element, even in the case that there is no MO related to the network element of the other party, on the graphical local craft terminal connected the network element, a MO can automatically be made and the network element of the other part can be accessed by just entering the system ID and address of the network element of the other party. In this way, a network system and a network management method can be provided that alleviate the load on a system administrator.

We claim:

1. A method for managing a network system via the managed object (MO) on network elements each of which is mutually connected, wherein each of said network elements contains system ID-address change function, the method comprising:
the step for a system administrator to input to first network element connected to a graphical local craft terminal, a system ID of a second network element under network management,
the step for said first network element to send an address inquiry Protocol Data Unit (PDU) to said second network element,
the step for said second network element to send back its own address to said first network element via said system ID-address change function,
the step for said first network element, based on the received information, to send to said second network element a PDU for generating a MO for its own element,
the step for said second network element, based on the PDU for generating the MO, to generate the MO for said first network element on its own network element,
the step for said second network element to send the PDU for generating a MO for its own network element to said first network element, and
the step for said first network element, based on the PDU for generating the MO, to generate the MO for said second network element.

2. A method for managing a network system via the MO on network elements each of which is mutually connected, wherein each of said network elements contains system ID-address change function, the method comprising:
the step for a system administrator to input to first network element connected to a graphical local craft terminal, a system ID of a second network element under network management,
the step for said first network element to send an address inquiry PDU to said second network element,
the step for said second network element to send back its own system ID-address to said first network element via the system ID-address change function,
the step for said first network element, based on the received information, to send a PDU for generating a MO for its own network element to said second network element,
the step for said second network element, based on the PDU for generating the MO, to generate the MO for said first network element on its own network element,
the step for said second network element to send the PDU for generating a MO for its own network element to said first network element, and
the step for said first network element, based on the PDU for generating the MO, to generate the MO for said second network element on its own network element.

3. A system for managing a network system via MO on network elements each of which is mutually connected, comprising
a graphical local craft terminal having a means to input a system ID and address,
a first network element connected to the graphical local craft terminal,
a second network element under network management which is performed via the graphical local craft terminal, wherein said first network element comprising:
a means to assemble a PDU for inquiring about the address from the system ID or a PDU for inquiring about the system ID from the address, and send these PDU to said second network element;
means to receive a PDU for generating a MO for said second network element from said second network element, and generate the MO for said second network element, said first network element further comprising
a system ID-address change function;
means to assemble a PDU for inquiring about the address from the system ID or a PDU for inquiring about the system ID from the address, and send these PDU to said second network element;
means to send the PDU for generating a MO for said second network element to said second network element;
means to receive from said second network element a PDU for generating the MO for second network element, and generate the MO for said second network element, said second network element comprising:
a system ID-address change function;
means to send back an address or system ID, based on a PDU for inquiring about the address from the system ID or a PDU for inquiring about the system ID from the address;
means to send a PDU for generating a MO for first network element to said first network element; and
means to receive from said first network element, a PDU for generating the MO for said first network element, and generate the MO for said first network element.
